(19) United States
(12) Patent Application Publication
(10) Pub. No.: US 2011/0157065 A1
(43) Pub. Date: Jun. 30, 2011

(54) TOUCH PANEL, DISPLAY DEVICE, AND ELECTRONIC DEVICE

(75) Inventors: Tetsuo Murata, Osaka-shi (JP); Yoshirou Kataoka, Osaka-shi (JP); Yasunobu Takusa, Osaka-shi (JP)

(73) Assignee: SHARP KABUSHIKI KAISHA, Osaka-shi, Osaka (JP)

(21) Appl. No.: 13/060,738

(22) PCT Filed: May 26, 2009
(86) PCT No.: PCT/JP2009/059625

§ 371 Date: Feb. 25, 2011

(30) Foreign Application Priority Data
Sep. 18, 2008 (JP) 2008-239828

(51) Int. Cl. G06F 3/041

(52) U.S. Cl. 345/173

(57) ABSTRACT

A display surface of the present invention includes a display operation surface (2) including an input operation surface (2a) that constitutes at least a part of the display operation surface (2), the input operation surface (2a) being configured to be directly touched by a user so that an input operation is performed, the input operation surface (2a) having a first region (3) and a second region (4) which are provided in a single substrate, the first region (3) being planar and substantially flat, and the second region (4) being protruded and/or recessed with respect to a reference plane which is an input surface the first region (3). It is therefore possible to realize (i) a touch panel which has further improved operator's operability and is provided to an electronic device having multi-functions, (ii) a display device including the touch panel, and (iii) an electronic device including the touch panel.

### TECHNICAL FIELD

The present invention relates to (i) a touch panel which is usable as input means for operating an electronic device or the like, (ii) a display device including the touch panel, and (iii) an electronic device including the touch panel.

### BACKGROUND ART

A touch panel has been widely used as input means for operating an electronic device having multi-functions, such as PDA (Personal Digital Assistant), an MP3 player, a car navigation system, or the like. The touch panel, which is transparent, is provided to the electronic device. The electronic device further includes display means, a display sheet, or the like behind the touch panel, so that a figure (such as an icon or the like), a text, or the like corresponding to a normally inputtable operation can be displayed. The display means can display different figures (such as icons or the like), texts, or the like in accordance with necessity, and the display sheet can display a fixed figure, text, or the like.

Thus, an operator of the electronic device can directly operate the touch panel which is the input means, while viewing the figures (such as icons or the like), texts, or the like that correspond to a variety of inputtable operations. Therefore, by employing the touch panel, it is possible to provide a user interface which is user-friendly irrespective of a user.

Also, in the electronic device having the multi-functions or the like, the touch panel is used in combination with the display means which can display the different figures (such icons or the like), texts, or the like in accordance with which application is being used. This can simplify input means that is otherwise very complex.

With the configuration, for example, it is possible to display different operation menus of a device or icons for different applications. Further, it is also possible to flexibly change an arrangement, though mechanical input means has a limitation that a predetermined arrangement cannot be changed.

A number of efforts have been made to improve operability, strength against bending, operation accuracy, or the like of the touch panel having the above-described advantages.

For example, Patent Literature 1 discloses a touch panel of a capacitive type including only a planar operation section in which a base substrate of a touch panel section shares a same substrate with an upper substrate of a display device. In the configuration, therefore, it is not necessary to provide an adhesive section for combining the base substrate of the touch panel section and the upper substrate of the display device. This can prevent the adhesive section from causing a change in a relative distance between the base substrate of the touch panel section and the upper surface of the display device at time when the touch panel is inwardly pressed down by a finger or the like. Therefore, it is possible to provide the touch panel which is thin and light in weight and has an improved operation accuracy.

Patent Literature 2 discloses a touch panel of a resistive film type configured as follows. The touch panel includes an intermediate section between upper and lower substrates which include upper and lower electrode layers facing each other and spaced apart from each other by a predetermined distance. The intermediate section is upwardly protruded in a dome shape, so that in a case where the touch panel is mounted on a lower surface of a chassis of an electronic device, the intermediate section sticks out from an opening of the chassis of the electrode device. The configuration makes it possible to provide the touch panel which has a good operability and causes less false detection.

Patent Literature 3 discloses a touch panel of a capacitive type in which an input surface of the touch panel has a curved surface shape. The curved surface shape of the input surface allows an operator to guess, by touching, that approximate part of the input surface which corresponds to a desirable operation. By pressing down, by a finger, the approximate part of the input surface thus guessed, the operator can perform the desirable operation without looking at the input surface.

Patent Literatures 4 and 5 disclose a touch panel which includes an input surface having a convexly curved surface shape. In the configuration, a stress imposed in the touch panel when the touch panel is pressed down is dispersed. Thus, it is possible to realize the touch panel having greater strength against bending.

### Citation List

Patent Literature 1

International Publication No. WO2008/050507 (Publication Date: May 2, 2008)

Patent Literature 2

Japanese Patent Application Publication, Tokukai, No. 2002-202855 A (Publication Date: Jul. 19, 2002)

Patent Literature 3

International Publication No. WO2007/099733 (Publication Date: Sep. 7, 2007)

Patent Literature 4

Japanese Patent Application Publication, Tokukai, No. 2001-154592 A (Publication Date: Jun. 8, 2001)

Patent Literature 5

Japanese Patent Application Publication, Tokukai, No. 2004-252676 A (Publication Date: Sep. 9, 2004)

### SUMMARY OF INVENTION

In a touch panel of Patent Literature 1 which includes only a planar operation section, an operator can perform an operation with high accuracy in a case where the operator performs the operation while looking at the touch panel. However, in a case where the operator performs the operation without looking at the touch panel, it is difficult for the operator to guess, based on texture, that approximate point in an input surface which corresponds to a desired operation. Thus, the operator has a difficulty in performing the operation with high accuracy. That is, unlike a touch panel which includes only a curved-surface operation section, the touch panel including only the planar operation section is not suitable for a scene in which the operator performs an operation without looking at the input surface. Thus, there is a problem that operability of the touch panel is reduced greatly in a situation that the operator cannot see/look at the input surface, e.g., the operator is in a darkened room or the operator is driving a vehicle.

Touch panels of Patent Literatures 2 to 5 include only a curved surface section. As described above, the configuration allows an operator to guess, based on texture, that approximate point in an input surface which corresponds to a desired operation. Thus, by pressing down, by a finger or the like, the approximate point in the input surface thus guessed, the operator can perform the desired operation without looking at the input surface. The touch panels of Patent Literatures 2 to 5 are, however, designed for use in which an input operation to the touch panel is so simple that the operator can perform it without particularly looking at an input surface. Thus, unlike a touch panel which includes only a planar section, the touch panels of Patent Literatures 2 to 5 are not suitable for use in which an input operation is complex. In such circumstances, there is a problem that it is difficult to realize, by use of a curved surface section, an input mode that is compatible only with the planar section (e.g., an input mode in which a pattern on an input surface is traced by a finger or a pen so that a text, a figure, or the like is inputted, or an input mode in which letter strings are arranged in a plane, like a keyboard style).

Therefore, considering operator operability, it is difficult that a touch panel which employs only one of a planar section and a curved surface section match an electronic device increasingly having multi-functions.

The present invention is made in view of the problems, and an object of the present invention is to provide (i) a touch panel which has further improved operator's operability and is provided to an electronic device having multi-functions, (ii) a display device including the touch panel, and (iii) an electronic device including the touch panel.

### Solution to Problem

Inventors of the present invention has conducted diligent study in order to attain the object, and found out a configuration in which a single touch panel includes a planar operation section and a curved-surface operation section, both of which are used as an operation section.

In order to attain the object, a touch panel of the present invention is a touch panel to be provided to an electronic device, which touch panel includes: a display operation surface including an input operation surface that constitutes at least a part of the display operation surface, the input operation surface being configured to be directly touched by a user so that an input operation is performed, the input operation surface having a first region and a second region which are provided in a single substrate, the first region of the input operation surface being planar and substantially flat, and the second region of the input operation surface being protruded and/or recessed with respect to a reference plane which is the first region of the input operation surface.

<Description of First Region>

The first region of the touch panel is substantially flat and has the planar structure. This, however, has a drawback that it is difficult for an operator to guess, based on texture and without looking at the input operation surface, that approximate point in the input surface which corresponds to a desired operation. Therefore, the first region of the touch panel has a disadvantage that operability of the touch panel is greatly decreased, for example, in a situation that the operator cannot see or look at the input operation surface, e.g., the operator is in a darkened room or the operator is driving a vehicle. On the other, there is an input mode that is compatible only with a planar and substantially flat structure (e.g., an input mode in which a pattern on an input surface is traced by a finger or a pen in order that the a text, a figure, or the like can be inputted, or an input mode in which letter strings are arranged in a plane, like a keyboard style). Further, the first region, which is planar and substantially flat, has no lens effect to be brought about in a second region being protruded and/or recessed with respect to a reference plane which is an input surface (which is later described) of the first region. This provides the first region with an advantage that a text, an icon, or the like, which is displayed on the input surface by display means provided behind the input surface or the like, can be further clearly viewed.

<Description of Second Region>

A shape of the second region, which is protruded and/or recessed with respect to a reference plane which is an input surface of the first region, can be any of a shape in which the second region is protruded with respect to the reference plane, a shape in which the second region is recessed with respect to the reference plane, a shape in which the second region is protruded and recessed with respect to the reference plane, and the like.

The second region has an advantage and a disadvantage which are substantially opposite to the advantage and the disadvantage of the first region. Specifically, since the second region is protruded and/or recessed with respect to the first region, it is very difficult to realize, in the second region, an input mode for which a flatness of an input surface is required, e.g., (i) an input mode in which an operator traces a pattern on an input surface by a finger or a pen so as to input a text, a figure, or the like, and (ii) an input mode in which letter strings like letter strings of a keyboard type are arranged on a planar surface. Further, the second region thus configured has a lens effect that makes it difficult to clearly see a text or an icon displayed on the input surface by the display means provided behind the input surface or the like. On the other hand, the second region thus configured allows the operator to guess, based on texture, that point in the input plane which is for a desired operation, and to press down, by a finger or the like, the point in the input plane thus guessed. Thus, the operator can perform the desired operation without looking at the input operation surface. The description above is merely illustrative, so that the present invention is not limited to this.

Thus, in the configuration, the input operation surface, which constitutes at least a part of the display operation surface of the touch panel provided to the electronic device, has the first region and the second region which are provided in a single substrate, the first region of the input operation surface being planar and substantially flat, and the second region of the input operation surface being protruded and/or recessed with respect to a reference plane which is the input surface of the first region of the input operation surface. With this, it is possible that the touch panel of the present invention has a greater advantage in operator's operability, as compared to a conventional touch panel that employs only one of the planar input operation section and the non-planar input operation section.

It is preferable that the touch panel of the present invention be configured so that the display operation surface has a part other than the input operation surface, the part of the display operation surface having at least a substantially flat part for mounting thereon a terminal for connecting a driving circuit to an external member or fixing the touch panel to a predetermined position.

In the configuration, at least the substantially flat part of the part of the display operation surface is used so as to mount thereon the terminal or to fix the touch panel to, for example, the chassis of the electronic deice or the display means. This can cause improvement in workability and thereby improvement in productivity. Additional, with the configuration, it is also possible to cause improvement in reliability.

Furthermore, it is preferable that the touch panel of the present invention be configured so that: in the first region of the input operation surface, whether the input operation is performed or not is determined based on whether the user touches an input surface or not; and, in the second region of the input operation surface, a state of the input operation is determined, based on a direction in which a touch point at which the user touches the input surface moves and a distance by which the touch point moves.

In the configuration, the first region of the input operation surface can be used as a point touch switch whereby whether the input operation is performed or not can be determined based on whether the operator touches the touch panel or not. It is therefore possible to realize (i) an input mode in which an input is determined based on whether the touch panel is touched or not, e.g., an application selection mode and a channel selection mode, (ii) an input mode in which letter strings are arranged in a plane, like a keyboard style, and the like. Further, with the configuration, it is also possible to realize an input mode in which one touch and longer touch are discriminated therebetween.

On the other hand, the second region of the input operation surface, which is protruded and/or recessed with respect to the reference plane which is the input surface of the first region of the input operation surface, is usable as a motion switch which can detect (i) a direction in which a contact point in an input surface, at which the operator touches the input surface, moves and (ii) a distance by which the contact point in the input surface moves. It is therefore possible to easily perform an operation in which a motion instruction, for which no location detection is necessary, is performed. Examples of the operation encompass an operation for increasing and decreasing a volume or a temperature, an operation for moving a cursor, an operation for page flipping, or the like.

The description made so far is merely illustrative, and the present invention is not limited to this.

By employing the first region and the second region compatible with the respective different input modes, as in the above configuration, it is possible to cause further improvement in operator's operability.

It is preferable that the touch panel of the present invention be configured so that the second region has at least a part having a dome shape, an ellipse shape, or a conical shape.

In the configuration, with the second region thus configured, it is possible that the operator further easily guess, based on texture, that point in the input plane which is for a desired operation. Thus, operation of the touch panel can be easily performed even in a darkened place, irrespective of a direction and an operator. It is therefore possible to cause further improvement in operability.

Furthermore, it is preferable that the touch panel of the present invention be configured so that the substrate has a uniform thickness.

In the configuration, the substrate has a uniform thickness so that a transmittance is more uniform and higher, as compared to a configuration in which a substrate has a bulk shape or the like. This brings about an effect that improves visibility of display, an icon, or the like which is shown on a lower layer of the touch panel.

Further, this can cause a reduction in thickness of and thereby a reduction in weight of the touch panel. Additionally, the touch panel is manufacturable by vacuum molding (punching) which has an advantage over injection molding or the like that it is easer to machine a die. Thus. It is possible to manufacture a variety of touch panels in large quantity by an easier method.

It is preferable that the touch panel of the present invention be configured so that the touch panel is a capacitive touch panel.

With the configuration, as compared to the resistive film type, it is not necessary to provide a highly accurate uniform gap section or to employ a structure which repeatedly changes and restores a shape of a substrate. In the configuration, therefore, it is possible to use a material which is relatively strong or a substrate which is greater in thickness. This makes it possible to manufacture a touch panel which has an excellent endurance. Furthermore, a structure of the configuration is relatively simple. As such, it is also possible to cause an increase in productivity.

It is preferable that the touch panel of the present invention further include an electrode section for determining whether the user touches the input surface or not, the electrode section being provided in that side of the substrate which is opposite to the input operation surface.

In the configuration, the substrate protects the electrode section which is a very thin layer. Therefore, it is not necessary to independently provide a protective layer for protecting the electrode section. This makes it possible to cause a reduction in manufacturing cost and a reduction in the number of manufacturing steps. Thus in turn brings about an effect that improves productivity of touch panels.

In the configuration, furthermore, an entire surface of the substrate can be processed so as to be smoother, or the substrate can be subjected to a surface working process or the like so that a part of or an entire part of the substrate has a different texture.

It is preferable that the touch panel of the present invention be configured so that the electrode section is single-layered.

In the configuration, the touch panel is the touch panel of the single-layered capacitive type. Therefore, it is not necessary to form a pattern in the electrode section in the first region or the second region. This can cause a reduction in the number of the manufacturing steps, and thereby improve productivity. Additionally, the configuration also makes it possible to realize a further reduction in thickness of the touch panel.

In order to attain the object, a display device of the present invention includes any of the touch panels thus configured and display means provided behind the display operation surface.

In the configuration, the display device includes any of the touch panels thus configured, and the display means which is provided behind the displaying operation surface which includes the input operation surface which the operator directly touches so as to perform the input operation. This allows the operator to directly operates the touch panel, which is the input means, while looking at figures, such as icons, or texts corresponding to a variety of inputtable operations. Therefore, it is possible to provide a user interface which is user-friendly irrespective of who the user is.

Further, it is possible that, in the electronic device which has multi-functions, different figures, such as icons, or texts corresponding to inputtable operations be displayed accordingly to which application is used. This can simplify the input means which is otherwise very complex. Additionally, with the configuration, it is possible to flexibly change an arrangement, whereas mechanically input means has a limitation that a predetermined arrangement cannot be changed.

It is preferable that the display device of the present invention be configured so that the display means is flexible and has a shape corresponding to the first region and the second region.

In the configuration, the display means is flexible. Therefore, it is possible to provide the display means in a shape corresponding to the shapes of the first region and the second region.

This makes it possible to cause a distance between the display means and the input operation surface of the touch panel to be uniform. It is therefore possible to provide the display device which is provided with the touch panel being free from luminance unevenness or the like and thereby having high display quality.

An electronic device of the present invention includes any of the display device thus configured.

Examples of the electronic device of the present invention encompass a mobile telephone, a telephone, a facsimile device, a printer, a copier, an information tool, a compact-size AV device, a large-size AV device, a personal computer, a television, a display device or an operation device for automobile use, a remote control device, a variety of electric appliances such as a refrigerator, a laundry machine, a microwave, and the like, a game console, and a similar electronic device, each of which includes a touch panel as an input operation surface for allowing an operator to perform an input operation. However, the present invention is not limited to any of them.

Since the configuration makes it possible to provide a user interface which is user-friendly irrespective of a use environment and a user, it is possible to realize an electronic device which has a greater advantage in operator's operability, as compared to an electronic device that includes a conventional touch panel employing only one of a planar section and a non-planar section.

### ADVANTAGEOUS EFFECTS OF INVENTION

As described earlier, a touch panel of the present invention is a touch panel, which is provided to an electronic device, the touch panel including: a display operation surface including an input operation surface that constitutes at least a part of the display operation surface, the input operation surface being configured to be directly touched by a user so that an input operation is performed, the input operation surface having a first region and a second region which are provided in a single substrate, the first region of the input operation surface being planar and substantially flat, and the second region of the input operation surface being protruded and/or recessed with respect to a reference plane which is the first region of the input operation surface.

As described earlier, a display device of the present invention includes the touch panel and display means provided behind the input operation surface.

As described earlier, an electronic device of the present invention includes the display device.

Therefore, the present invention brings about an effect that noticeably improves operators' operability, as compared to a conventional touch panel including only one of a planar section and a non-planar section.

Further, the electronic device of the present invention includes the touch panel and the display means which is provided behind the input operation surface. This allows the operator to directly operate the touch panel, which is the input means, while looking at figures, such as icons, and texts corresponding to a variety of inputtable operations. It is therefore possible to provide a user interface which is user-friendly irrespective of a user.

Furthermore, the configuration makes it possible that, in the electronic device which has multi-functions, different figures, such as icons, or texts corresponding to the inputtable operations be displayed accordingly to which application is used. This can simplify the input means which is otherwise very complex. Additionally, with the configuration, it is possible to flexibly change an arrangement of display, whereas mechanically input means has a limitation that a predetermined arrangement cannot be changed.

An electronic device of the present invention includes the display device thus configured. This makes it possible to provide a user interface which is user friendly irrespective of a use environment and a user. It is therefore possible to realize an electronic device which has a greater advantage in operator's operability, as compared to an electronic device that including a conventional touch panel employing only one of the planar section and the non-planar section.

### BRIEF DESCRIPTION OF DRAWINGS

FIG. 1 is a plan view showing a configuration of an input operation surface of an electronic device, in accordance with one embodiment of the present invention.

FIG. 2 is a cross sectional view taken on a line AA of FIG. 1.

FIG. 3 is a cross sectional view showing main constituents of an electronic device in accordance with another embodiment of the present invention, the electronic device including display means which is a flexible display device.

FIG. 4 is a cross sectional view showing main constituents of an electronic device in accordance with still another embodiment of the present invention, the electronic device including display means which is a flexible display device.

FIG. 5(a) is a plan view showing an electrode structure which is included in a touch panel of a single-layered capacitive type provided to an electronic device, in accordance with the one embodiment of the present invention.

FIG. 5(b) is a cross sectional view taken on a line BB of FIG. 5(a).

FIG. 6(a) is a plan view showing an electrode structure included in a touch panel of a two-layered capacitive type.

FIG. 6(b) is a cross sectional view taken on a line CC of FIG. 6(a).

FIG. 7(a) is a plan view showing an electrode structure included in a touch panel of a resistive film type.

FIG. 7(b) is a cross sectional view taken on a line DD of FIG. 7(a).

FIG. 8(a) is an enlarged view showing a part of a transparent substrate on which a transparent conductive film having a linearization pattern is deposited.

FIG. 8(b) is a cross sectional view taken on a line EE of FIG. 8(a).

FIG. 9(a) is a view showing one example of a display operation surface including second operation sections of a various types of shapes.

FIG. 9(b) is a view showing another example of the display operation surface including the second operation sections of the various types of shapes.

FIG. 9(c) is a view showing still another example of the display operation surface including the second operation sections of the various types of shapes.

### DESCRIPTION OF EMBODIMENTS

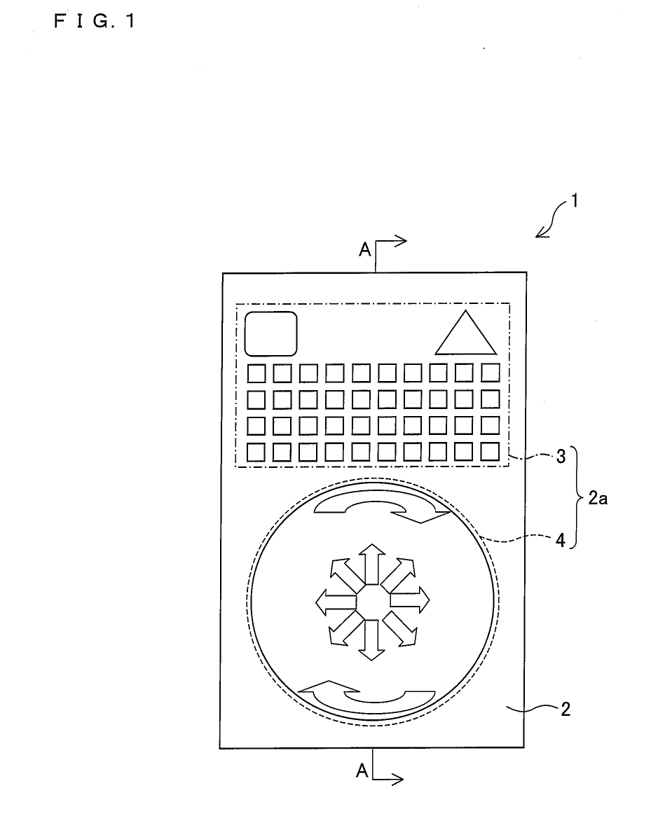

One embodiment of the present invention is described below with reference to FIGS. 1 through 9.

### Embodiment 1

Description in the present embodiment is made with respect to an electronic device 1 which includes (i) a display panel 5 and (ii) a liquid crystal display device 6 which is display means. The touch panel 5 includes an input operation surface 2a for allowing an operator to directly touch the input operation surface 2a so as to perform an input operation. The liquid crystal display device 6 is provided behind a display operation surface 2 that includes the input operation surface 2a.

FIG. 1 is a plan view showing the electronic device 1 from that side of the input operation surface which faces the operator, in accordance with the present embodiment.

As shown in FIG. 1, the electronic device 1 includes the input operation surface 2a for allowing the operator to perform an input operation. The input operation surface 2a is provided in the touch panel 5 (which is later described), and includes a first operation section 3 and a second operation section 4.

The first operation section 3 is one example of a first region of the input operation surface 2a in the touch panel 5. The first region of the input operation surface 2a is planar and substantially flat. The second operation section 4 is one example of a second region of the input operation surface 2a in the touch panel 5. The second region of the input operation surface 2a is protruded and/or recessed with respect to a reference plane which is an input surface of the first region of the input operation surface 2a.

The first operation section 3 and the second operation section 4 are later described in detail.

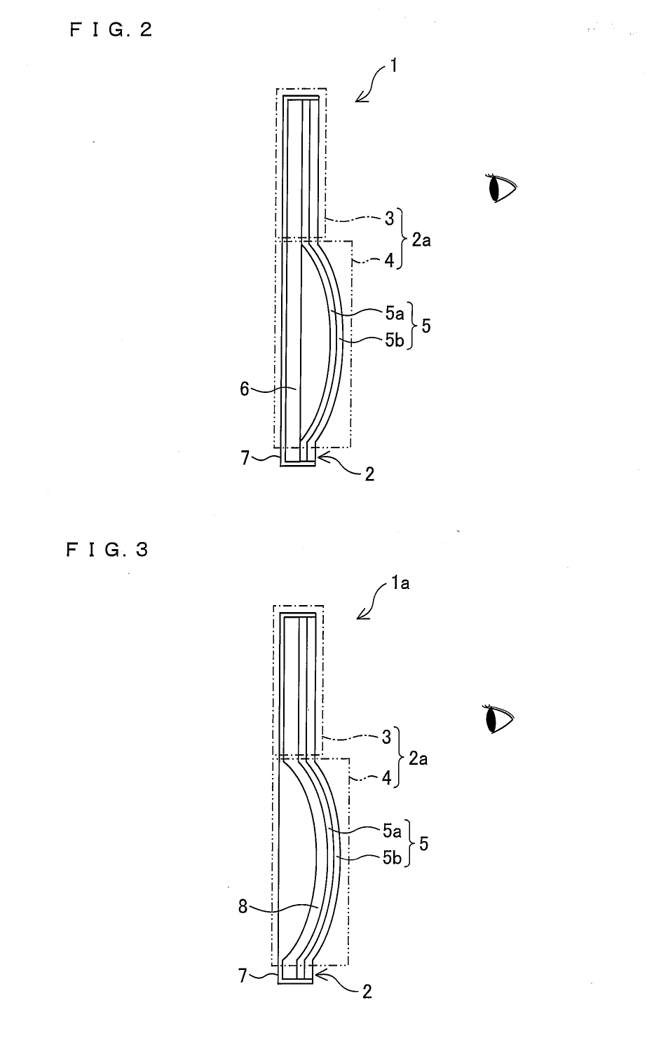

FIG. 2 is a cross sectional view taken on a line AA of FIG. 1 and showing the electronic device 1 shown in FIG. 1.

As shown in FIG. 2, the first operation section 3 is planar and substantially flat. The second operation section 4 is protruded and/or recessed with respect to the reference plane which is the input operation surface 2a in the first operation section 3. The first operation section 3 and the second operation section 4 are provided in the touch panel 5 of a single-layered capacitive type (which is later described in detail). The touch panel 5 further includes a transparent conductive film 5a and a transparent substrate 5b.

The liquid crystal display device 6 is the display means which is provided behind and faces that side of the touch panel 5 which is opposite to the input operation surface 2a. The configuration allows the operator to operate the electronic device 1 by touching, with a finger or a pen, the first operation section 3 or the second operation section 4 of the input operation surface 2a of the touch panel 5 while viewing an icon, such as a figure or the like, a text or the like displayed by a display section of the liquid crystal display device 6.

In the electronic device 1 thus configured, the first operation section 3 and the second operation section 4 of the input operation surface 2a have different shapes. Thus, if the first operation section 3 and the second operation section 4 of the input operation section 2a are allocated to input operations suitable for their respective different shapes, then it is possible to cause an increase in operator's operability, as compared to operability of an electronic device with a conventional touch panel including only one of a planar operation section and a non-planar operation section.

<First Operation Section>

Particularly, in the first operation section 3 of the touch panel 5, it is difficult that the operator guesses, based on texture and without looking at the input operation surface 2a, that approximate point in the input operation surface 2a which corresponds to a desired input operation. In such circumstances, in a situation that the operator cannot see/look at the input operation surface 2a, e.g., the operator is in a darkened room or the operator is driving a vehicle, it is difficult that the operator performs an input operation by using the first operation section 3.

The conventional touch panel, whose input section includes only the planar operation section, has the following limitation from the same reason as described above. That is, in a situation that the operator cannot see/look at the input section, there is caused a great reduction in operability.

However, there is an input mode compatible only with the first operation section 3 (e.g., an input mode which is relatively complex, such as (i) an input mode in which a pattern on an input surface is traced by a finger or a pen so that a text, a figure, or the like is inputted, or (ii) an input mode in which letter strings similar to those in a keyboard type are arranged in a plane). Further, the first operation section 3 has no lens effect caused in the second operation section 4 which is configured in a non-planar structure. Therefore, in the first operation section 3 which is configured in a planar structure, it is possible to more clearly view a icon, such as a figure or the like, a text or the like which is displayed by the display means provided behind the touch panel 5, as compared to the second operation section 4.

<Second Operation Section>

The second operation section 4, which is protruded and/or recessed with respect to the reference plane which is the input surface of the first operation section 3, can have a shape in which the second operation section 4 is protruded with respect to the reference plane, a shape in which the second operation section 4 is recessed with respect to the reference plane, a shape in which the second operation section 4 is protruded and recessed with respect to the reference plane, or the like.

The second operation section 4 thus configured has a feature substantially opposite to that of the first operation section 3. That is, in the second operation section 4 which is protruded or recessed with respect to the first operation section 3, it is very difficult to realize the input mode which is relative complex and for which flatness of an operation surface is required, e.g., (i) an input mode in which a pattern on an input surface is traced by a finger or a pen so that a text, a figure, or the like is inputted, or (ii) an input mode in which letter strings similar to those in a keyboard type are arranged in a plane. Further, the second operation section 4 has a lens effect. In the second operation section 4, therefore, it is difficult to clearly view an icon, such as a figure or the like, a text or the like, which is displayed by the display means provided behind the touch panel 5 or the like.

However, the second operation section 4 has an advantage that, in the second operation section 4, the operator can perform a desired input operation without looking at the input operation surface 2a, by (i) guessing, based on texture, that approximate point in the input operation surface 2a which corresponds to the desired input operation and (ii) pressing down, with a finger or the like, the approximate point in the input operation surface 2a thus guessed.

The second operation section 4 can have a circular shape, an oblong shape, a triangular shape, a quadrangular shape, a pyramidal shape, a conical shape, a frustum shape having a flat top surface, a curved shape, or the like.

It is preferable that the touch panel 5 of the present embodiment, which is provided to the electronic device 1, be configured so that the second region 4 has at least a part having a dome shape, an ellipse shape, or a conical shape.

With the configuration, it is possible that, in the second operation section 4, the operator further easily guess, based on texture, that approximate point in the input surface 2a which corresponds to a desired operation. Therefore, the operator can easily perform the desired operation even in a darkened place, irrespective of (i) a direction in which the operator operates the electronic device 1 and (ii) who operates the electronic device 1. This can cause a further increase in operability.

<Effect Brought about by Input Operation Surface including First Operation Section and Second Operation Section>

The following description is made with respect to a remote controller device, which is one example of an electronic device, in purpose of discussing an effect brought about by a configuration in which the input operation surface 2a includes both the first operation section 3 and the second operation section 4. Further, the following description is also made with respect to a combination of use examples of the single first operation section 3 and the second operation section(s) 4, in order to fulfill the same purpose. However, the present invention is not limited to any of the examples.

An input operation section of the remote controller device is so that a first operation section is planar and substantially flat, and a second operation section is protruded and/or recessed with respect to a reference plane which is an input surface of the first operation section. Thus, even in a case where the operator uses the remote controller device in a darkened room, for example, the operator can roughly distinguish between the first operation section and the second operation section, based on texture and without looking at the input operation section.

Therefore, in a case where the second operation section 4 has a function to perform power on/off, for example, the operator can use the second operation section 4 so as turn on/off a corresponding electronic device and the display means of the controller device, or the like. Thus, even in the darkened room, the operator can perform a variety of inputting, by operating one of input operation surfaces (an input operation surface which is planar and an input operation surface which is protruded and/or recessed) while viewing an icon, such as a figure, a text or the like displayed by the display means.

As described above, the touch panel 5 of the present embodiment, which is provided to the electronic device 1, includes the display operation surface 2 including the input operation surface 2a that constitutes at least a part of the display operation surface 2, the input operation surface 2a being configured to be directly touched by the operator so that an input operation is performed, the input operation surface 2a having the first operation section 3 and the second operation section 4 which are provided in a single substrate, the first operation section 3 of the input operation surface 2a being planar and substantially flat, and the second operation section 4 of the input operation surface 2a being protruded and/or recessed with respect to the reference plane which is the input surface of the first operation section 3 of the input operation surface 2a. Thus, it is possible to obtain the touch panel 5 which is very excellent in operator's operability over a conventional touch panel that includes only one of a planar operation section and a non-planar operation section.

Further, the electronic device 1 of the present embodiment includes the touch panel 5 and the display means provided behind the display operation surface 2.

With the configuration, it is possible to directly operate the touch panel 5 which is the input means, while viewing figures, such as icons or the like, texts or the like which correspond to a variety of inputtable operations. This makes it possible to provide a user interface which is user-friendly irrespective of a user.

Furthermore, it is possible that, in an electronic device having multi-functions, different figures (icons or the like), texts, or the like corresponding to inputtable operations can be displayed in accordance with which application is being run. This allows input means, which can be otherwise very complex, to be simple. Furthermore, with the configuration, it is possible to flexibly change an arrangement, though mechanical input means has a limitation that a predetermined arrangement cannot be changed.

It is preferable that the touch panel 5 of the present embodiment, which is provided to the electronic device 1, be configured so that: in the first operation section 3 of the input operation surface 2a, whether the input operation is performed or not is determined based on whether the operator touches an input surface or not; and in the second operation section 4 of the input operation surface 2a, a state of the input operation is determined, based on a direction in which a touch point at which the operator touches the input surface moves and a distance by which the touch point moves.

It is preferable that the first operation section 3, which is planar and substantially flat, be used as a point touch switch whereby whether an input operation is performed or not is determined based on whether the input surface is touched or not. An input mode compatible with the point touch switch encompass an input mode in which whether inputting is performed or not is determined based on whether the input surface is touched or not, e.g., (i) an application selection mode, (ii) a channel selection mode, (iii) an input mode in which a letter strings similar to those in a keyboard type are arranged in a plane, and the like. Further, the input mode compatible with the point touch switch also encompasses an input mode in which one-touch and prolonged touch are distinguished therebetween.

It is preferable that the second operation section 4, which is protruded and/or recessed with respect to the reference plane which is the input surface of the operation section 3, be used as a motion switch which can detect (i) a direction in which a contact point in the input surface, at which the operator touches the input surface, moves and (ii) a distance by which the contact point in the input surface moves. An input operation detectable by the motion switch encompasses an input operation in which a motion instruction, for which no point detection is necessary, is issued, e.g., (i) an input operation for increasing/decreasing a volume or a temperature, (ii) an input operation for moving a cursor, (iii) an input operation for moving to another page, or the like.

The description above is merely illustrative, to which the present invention is not limited.

With the configuration in which the first operation section 3 and the second operation section 4 are compatible with respective different input modes, as described above, it is possible to cause a further increase in operator's operability.

It s preferable that the touch panel 5 of the present embodiment, which is provided to the electronic device 1, be configured so that the display operation surface 2 has a part other than the input operation surface 2a, the part of the display operation surface 2 having at least a substantially flat part for mounting thereon a terminal for connecting a driving circuit to an external member or fixing the touch panel 5 to a predetermined position.

In the configuration, at least the substantially flat part of the display operation surface 2 is used so as to mount thereon the terminal or so as to fix the touch panel 5 to, for example, a chassis of the electronic device 1 or the display means. This can cause an increase in workability. Thus, it is possible to cause increases in productivity and reliability.

FIG. 3 is a cross sectional view showing main constituents of an electronic device 1a in accordance with another embodiment of the present invention, the electronic device 1a including a flexible display device 8 which is display means.

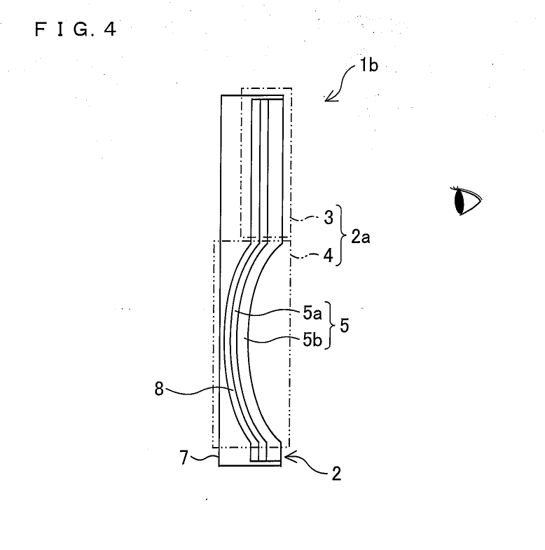

FIG. 4 is a cross sectional view showing main constituents of an electronic device 1b in accordance with still another embodiment of the present invention, the electronic device 1b including a flexible display device 8 which is display means.

In the electronic device 1 shown in FIG. 2, the liquid crystal display device 6, which is a normal display device configured planar and inflexible, is display means. However, it is alternatively possible to use, in replacement of the liquid crystal display device 6, a flexible display device 8 which is made form a flexible substrate. The flexible display device 8 can be freely bended accordingly to shapes of the first operation section 3 and the second operation section 4. Thus, with the alternative configuration, it is possible to provide the display means having a shape corresponding to the shapes of the first operation section 3 and the second operation section 4.

For example, it is possible to realize the electronic device 1a including the flexible display device 8 which is planar in the first operation section 3 and curved along a protruding and curved surface in the second operation section 4 (see FIG. 3). Further, the second operation section 4 can be protruded and/or recessed with respect to the reference plane which is the operation surface of the first operation section 3. Therefore, for example, it is also possible to realize the electronic device 1b including the flexible display device 8 which is planar in the first operation section 3 which is planar, and curved along a recessed and curved surface of the second operation section 4 (see FIG. 4).

As described above, it is preferable that the display means be flexible and have a shape corresponding to the shapes of the first operation section 3 and the second operation section 4.

With the configuration, it is possible to cause the display mean and the input operation surface 2a of the touch panel 5 to be spaced apart from each other by a uniform distance. This makes it possible to realize a display device provided with a touch panel which has no luminance unevenness or the like and thereby has higher display quality.

The electronic device 1 of the one embodiment of the present invention includes the display device thus configured. This can provide a user interface which is user-friendly irrespective of a use environment and a user. It is therefore possible to realize an electronic device which is very excellent in operator's operability over an electronic device including a conventional touch panel which includes only one of the planar operation section and the non-planar operation section.

The following description discusses in more detail the electrode structure of a single-layered capacitive type which is included in the touch panel 5 provided to the electronic device 1 of the one embodiment of the present invention.

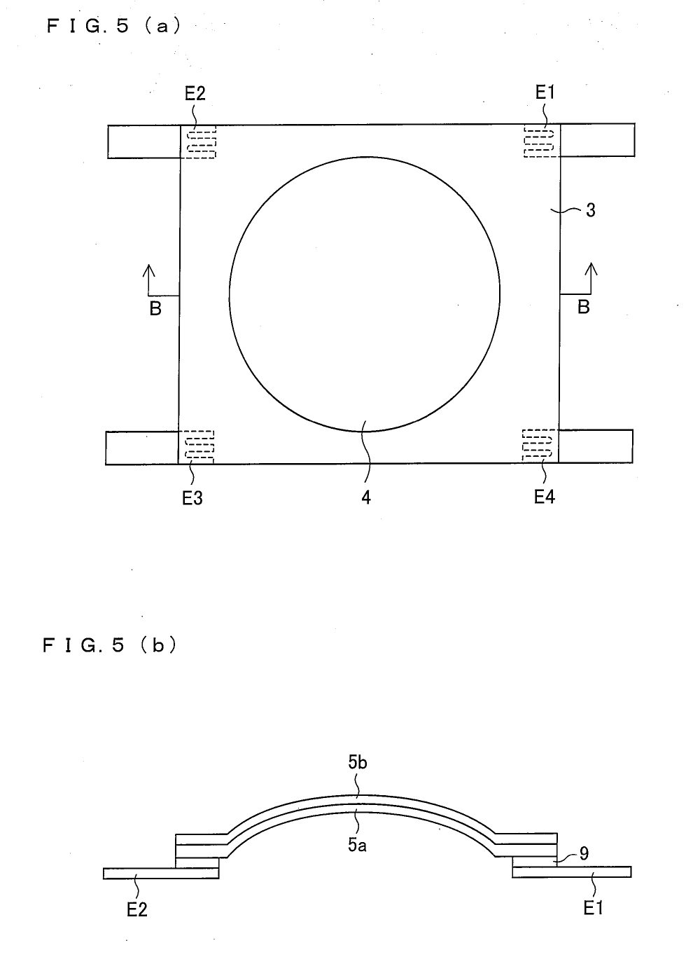

FIG. 5(a) is a plan view showing an electrode structure of a single-layered capacitive type in the touch panel 5, in accordance with one embodiment of the present invention. FIG. 5(b) is a cross sectional view taken on a line BB of FIG. 5(a).

As shown in FIG. 5(a), the touch panel 5 includes four electrodes E1 to E4 which are provided to respective edge parts of the touch panel 5 and which have a comb shape. Each of the four electrodes E1 to E4 is electrically connected to a touch detection section (which is not shown in FIG. 5(a)) via a predetermined signal line.

Also, as shown in FIG. 5(b), the touch panel 5 includes the electrode structure of the single-layered capacitive type. Thus, the transparent conductive film 5a is not patterned on a lower surface (which is an opposing surface of the input surface that faces the operator who performs an input operation) of the transparent substrate 5b in which the first operation section 3 and the second operation section 4 as described above are provided. Instead, the transparent conductive film 5a is provided on an entire part of the lower surface of the transparent substrate 5b. Further, each of the four electrodes E1 to E4 is electrically connected to the transparent conductive film 5a via a conductive rubber, a conductive paste, or a connector member 9 having a conductive property.

In the electrode structure of the single-layered capacitive type, a predetermined alternating voltage is applied to the four electrodes E1 to E4. Then, currents which flow through the respective four electrodes E1 to E4 are measured. Then, an operation point is determined based on measured values of the currents flowing through the respective four electrodes E1 to E4.

Specifically, when the operator touches the touch panel 5 by operating means such as a finger or the like, the operation point and the operator's body are capacitively-coupled with each other. This causes a change in impedance of the touch panel 5, in relative to impedance of the electrodes E1 to E4. As such, values of the currents which flow through (i) the respective four electrodes E1 to E4, (ii) the transparent conductive film 5a and the transparent substrate 5b of the touch panel 5, and (iii) the operating means such as a finger or the like, to the operator are changed accordingly to the change in the impedance of the touch panel 5. As such, in a situation that the operator touches the touch panel 5 by the operating means such as a finger or the like, the values of the currents which flows through the respective four electrodes E1 to E4 are varied based on (i) a position of a contact point at which the operating means such as the finger or the like is in contact with the touch panel 5, and (ii) an amount of coupling capacitance between the touch panel 5 and the operator's body. Thus, in a case where the operator operates the touch panel 5, it is possible to locate a position of the operation point.

The transparent substrate 5b can be made from a transparent film such as a polyethylene terephthalate film or the like, polycarbonate, an acrylate resin, or the like. Further, the transparent substrate 5b can also be made from soda glass, borosilicate glass, heat-resisting glass, or the like.

It is preferable that the transparent substrate 5b have a thickness determined in consideration of sensitivity to touch, durability, and the like. For example, in the present embodiment, the transparent substrate 5b is made from polycarbonate. In this case, it is preferable that the transparent substrate 5b have a thickness not greater than 2 mm, in consideration of the sensitivity to touch.

Furthermore, it is preferable that the transparent substrate 5b have a uniform thickness.

With the configuration in which the transparent substrate 5b thus has the uniform thickness, it is possible to obtain a transmittance which is more uniform and higher than that in a configuration in which a substrate has a bulk shape or the like. This makes it possible to cause an increase in visibility of display, an icon, or the like displayed by the display device provided on that surface of the touch panel 5 which is opposite to the display operation surface 2, or the like.

Further, with the configuration, it is also possible to cause a reduction in thickness of the touch panel 5. As such, it is possible to cause a reduction in weight of the touch panel 5. Furthermore, the touch panel 5 is manufacturable by vacuum molding (punching) for which machining of a die is easer than for injection molding or the like. Thus, it is possible to manufacture, by an easier way, various types of touch panels 5 in a large quantity.

The transparent conductive film 5a can be prepared by depositing an ITO (Indium Tin Oxide) film, an IZO (Indium Zinc Oxide) film, or the like on the transparent substrate by sputtering. Alternatively, the transparent conductive film 5a can be a conductive film made from an organic film.

The transparent substrate 5b can be prepared by combining mold products. Normally, however, the transparent substrate 5b is a single substrate. The transparent substrate 5b is prepared by injection molding, or one or more transparent substrates 5b are vacuum-molded in a plate material, and then, contours of the one or more transparent substrates 5b are cut out by punching or the like. In a case where a film is deposited on the transparent substrate 5b by vacuum film forming, the step of depositing the film can be performed prior to or after the transparent substrate 5b is worked. This can be determined based on a film-forming property of a material. However, a touch detection electrode should be prepared to have a relatively higher resistivity and a smaller thickness. In such circumstances, it may be necessary, in some manufacturing processes, to avoid a structure in which a joint part between the first operation section 3, which is planar, and the second operation section 4, which is non-planar, is inclined at a very large angle or a very small angle.

In a case where the transparent substrate 5b is molded after deposing a film thereon, it is necessary to make sure that the film is prevented from being damaged or being broken by deformation distortion. For this, it is necessary to design a structure in which deformation is small or to arrange a die. In a case where the film is an organic conductive film, the film can be provided, by printing or patterning (ink jet printing, laser patterning, or the like), after the transparent substrate 5b is molded.

In the embodiments of the present invention, it is preferable that the transparent conductive film 5a, which is provided for detecting touch on the touch panel 5, be provided behind the input operation surface 2a.

In the configuration, the transparent substrate 5b protects the transparent conductive film 5a which is a very thin film (a film thickness of approximately 10 nm to 30 nm). This makes it unnecessary to independently provide a protective film for protecting the transparent conductive film 5a. Thus, it is possible to cause a reduction in manufacturing cost. Further, it is also possible to cause a decrease in the number of manufacturing steps, and this can cause an increase in productivity.

With the configuration, furthermore, it is also possible to cause a change in texture of a part or an entire part of the transparent substrate 5b, by smoothening an entire surface of the transparent substrate 5b or performing a surface finishing process for the transparent substrate 5b.

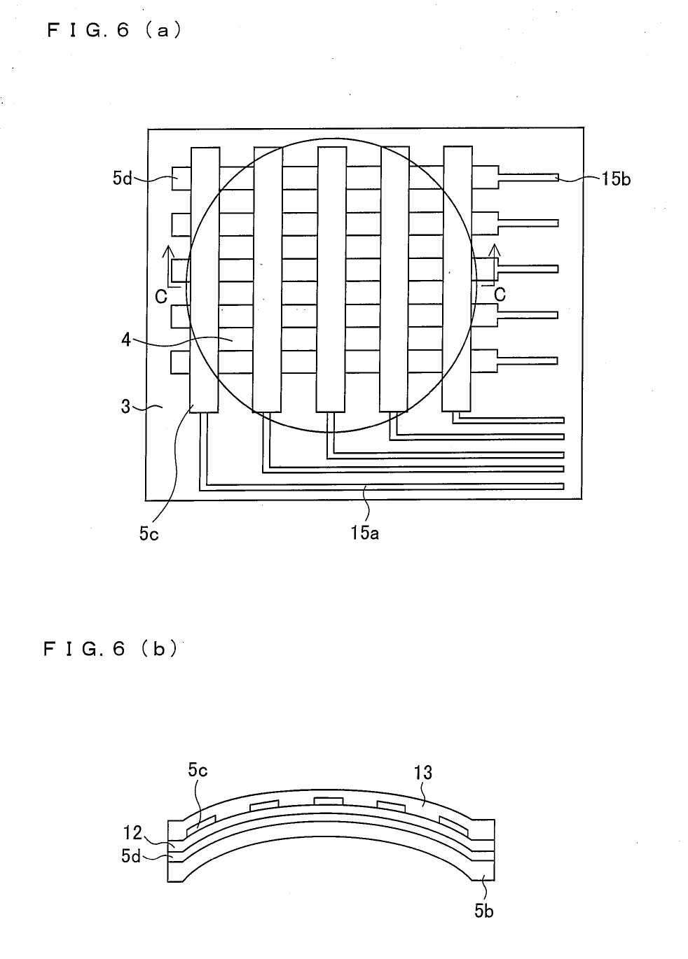

In the one embodiment of the present invention, the electrode structure is the single-layered capacitive type shown in FIGS. 5(a) and 5(b) is used. However, it is possible to alternatively employ an electrode structure of another type, such as an electrode structure of a two-layered capacitive type (which is later described) shown in FIGS. 6(a) and 6(b) or the like, in accordance with a feature of an electronic device to be used.

FIG. 6(a) is a plan view showing an electrode structure of a two-layered capacitive type. FIG. 6(b) is a cross sectional view taken on a line CC of FIG. 6(a).

In the electrode structure of two-layered capacitive type shown in FIG. 6, 5c is indicative of a vertical electrode for detecting a touch coordinate in a direction X (horizontal direction), and 5d is indicative of a horizontal electrode for detecting a touch coordinate in a direction Y (vertical direction). An insulating film 12, which is an inorganic or organic film, is provided between the vertical electrode 5c and the horizontal electrode 5d. Further, a protective layer 13, which is an inorganic or organic film, is provided in a single or multiple layers above the vertical electrode 5c. 15a is indicative of a line which is drawn out and connects the vertical electrode 5c to an external device. 15d is indicative of a line which is drawn out and connects the horizontal electrode 5d to an external device.

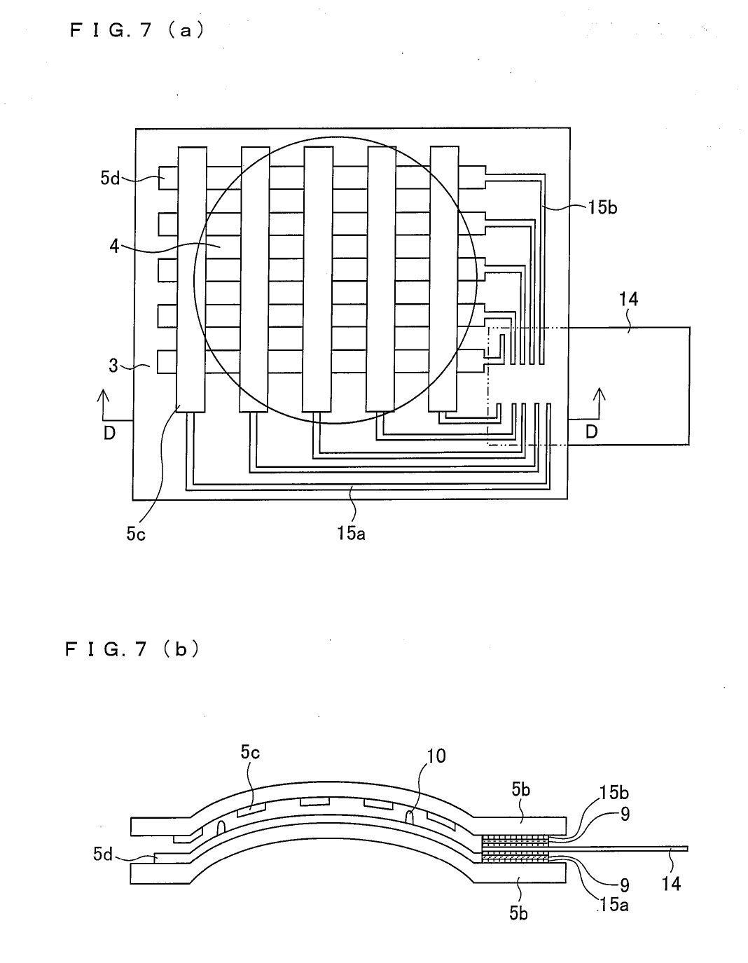

FIG. 7(a) is a plan view showing an electrode structure of a resistive conductive film type. FIG. 7(b) is a cross sectional view taken on a line DD of FIG. 7(a).

As shown in FIG. 7, the electrode structure of the resistive film type is so that (i) transparent substrates 5b, which face each other, are spaced apart from each other by a predetermined distance by a spacer 10, and (ii) an upper transparent electrode 5c is provided on one of the transparent substrates 5b, and a lower transparent electrode 5d is provided on the other one of the transparent substrates 5b. When an input surface of a substrate is pressed down, the upper transparent electrode 5c is caused to be in contact with the lower transparent electrode 5d so that a flow of a current is generated. In the electrode structure of the resistive film type, the flow of the current thus generated is measured. 15a is indicative of a line which is drawn out and connects the upper transparent electrode 5c to an external device. 15b is indicative of a line drawn out and connects the lower transparent electrode 5d to an external device. An external signal relay substrate 14 is made from FPC, a hard substrate, or the like. The external signal relay substrate 14 is electrically connected to the lines 15a and 15b via a conductive rubber, a conductive paste, or a conductive connector member 9.

A method for detecting touch made on the touch panel 5 encompasses a variety of types such as (i) a detection method of a capacitive type which is employed in the present embodiment and shown in FIGS. 5(a), 5(b), 6(a), and 6(b), (ii) a detection method of a resistive film type which is shown in FIGS. 7(a) and 7(b), (iii) a detection method of an ultrasonic type in which a sound wave is absorbed, (iv) a detection method of an infrared type in which a position of the touch is detected by blocking infrared light emitted from a light emitting device or by receiving reflected light by a light receiving device, (v) a detection method of an electromagnetic induction type in which electromagnetic induction is employed, or the like.

It is preferable that the touch panel 5 of the one embodiment of the present invention, which is provided to the electronic device 1, be configured so that the touch detection method is the electrode structure of the capacitive type as described above.

In the configuration, in comparison with another configuration in which the detection method is the electrode structure of the resistive film type, it is not necessary to provide any gap section which is uniform and prepared with high accuracy. Further, in the configuration, it is not necessary to repeatedly change and restore a shape of a substrate. As such, it is possible to use a material relatively greater in strength and a substrate greater in thickness. This in turn makes it possible to manufacture a touch panel having an excellent durability. Furthermore, the configuration is relative simple. Thus, it is possible to cause an increase in productivity.

It is preferable that the touch panel 5 of the one embodiment of the present invention, which is provided to the electronic device, be configured so that the transparent conductive film 5a for detecting touch made on the touch panel 5 is single-layered as shown in FIGS. 5(a) and 5(b).

In the configuration, the touch panel 5 is the single-layered capacitive type. Thus, in the first operation section 3 and the second operation section 4, it is not necessary to provide any pattern in an electrode section for detecting touch made on the touch panel 5. This in turn makes it possible to cause a reduction in the number of manufacturing steps and an increase in productivity. Further, it is also possible to cause a further reduction in thickness of the touch panel 5.

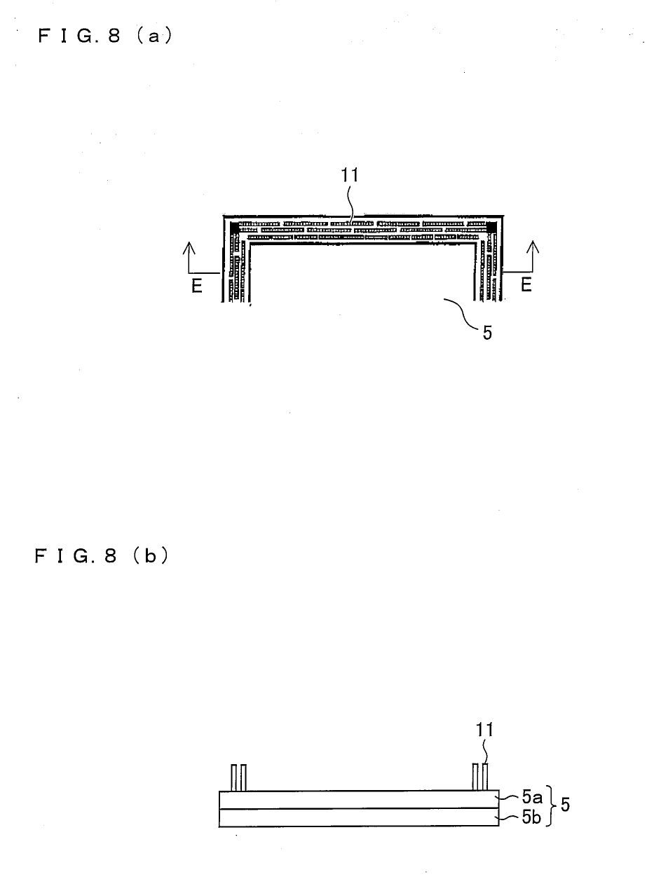

FIGS. 8(a) and 8(b) are views showing a linearization pattern.

FIG. 8(a) is an enlarged view showing a part of the transparent substrate 5b on which the transparent conductive film 5a, which includes a linearization pattern 11, is deposited. FIG. 8(b) is a cross sectional view taken on a line EE of FIG. 8(a).

An electric field, which is generated across the transparent conductive film 5a for detecting touch made on the touch panel 5, is normally nonuniform. Thus, there is a problem that it is impossible to obtain high touch detection accuracy.

In order to solve the problem, it is preferable to provide, in an outer circumference region of the transparent conductive film 5a, the linearization pattern 11 for helping uniformizing curves of the electric field.

The linearization pattern 11 can be made from any material, provided that the material is stable and has a predetermined resistivity. Examples of the material encompass a vacuum film forming material and a metal coat film forming material, each of which is made from Al, Ti, Mo, Cu or the like, or an alloy thereof. Further, a resistivity of a material of the transparent conductive film 5a can be reduced by causing an increase in thickness of the material of the transparent conductive film 5a. Furthermore, the linearization pattern 11 can be made from another material, which can be a conductive paste prepared by (i) decomposing a conductive substance, such as silver, copper, or the like, to a polymer like an epoxy material and then (ii) inking the polymer.

A method for forming the linearization pattern 11 can be any of various types of methods such as screen printing, sputtering, etching, and the like.

In the electronic device 1 of the one embodiment of the present invention, the display means is the liquid crystal display device 6 including a backlight, the liquid crystal display device 6 being a normal display device which is planar and inflexible as shown in FIG. 2.

In each of the electronic device 1a and 1b of other embodiments of the present invention, the flexible display device 8, which is bendable freely, is a reflective TFT LCD. However, the embodiments of the present invention are not limited to this. Instead, the flexible display device 8 can be a member, such as organic EL, electronic paper, or LED, which includes an array of light emitters.

Furthermore, the display means can be any of a variety of display devices having a non-planar structure, a display device in which screens are automatically switched among one another (e.g., a screen in an entire part of a dome section is switched to another screen, an image on a back surface is moved slightly by a structure in which fine slits or holes are arranged), a plasma display device, and the like.

<Various Variations of Second Operation Section>

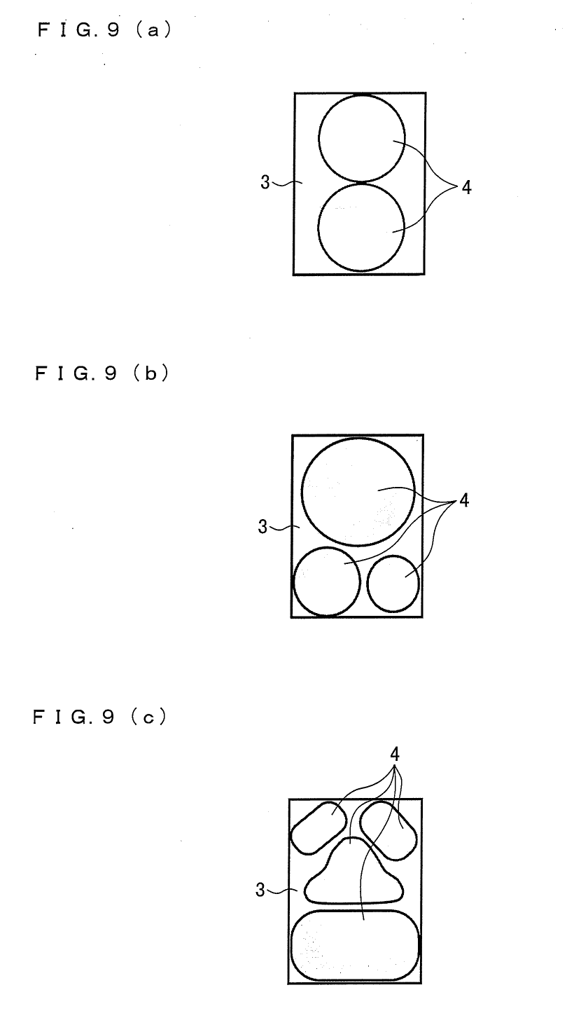

FIGS. 9(a) to 9(c) are views showing the display operation surface 2 including second operation sections 4 of various types of shapes.

The second operation sections 4 of a variety of shapes are used in combination as shown in FIGS. 9(a) to 9(c), and this can allow, for example, an individual with vision disability to operate an electronic device or an individual in a situation, where he cannot see the display operation surface 2 of an electronic device, to operate the electronic device.

The greater the variations and the numbers of the shape of the second operation sections 4 are, the more improved a position detection accuracy can be.

FIG. 9(a) shows the display operation surface 2 including second operation sections 4 which are suitable in a scene that operators face each other, i.e., this type of the display operation surface 2 is suitable in a monitor for use in business negotiation, a game console allowing players to play against each other, or the like.

FIG. 9(b) shows a display operation surface 2 including second operation sections 4 (i) which are used to realize respective different functions (operation screens) so that it is possible to quickly operate many functions without switching function screens among one another, and (ii) which have different sizes determined accordingly to a degree of motion operation, so as to enhance usability.

FIG. 9(c) shows the display operation surface 2 including second operation sections 4 which are usable in an object in an amusement park or a play-toy for children in such a manner as to (i) be arranged in a pattern similar to a human face so as to render amusingness, and (ii) have respective different display colors so as to cause a further increase in the effect of rendering the amusingness.

The touch panel 5 of the one embodiment of the present invention, which is provided to the electronic device, has a very excellent operator's operability over a conventional touch panel including only one of the planar operation section and the non-planar operation section.

The electronic device includes the touch panel 5 and the display means which is provided behind the input surface. This allows the operator to directly operate the touch panel 5, which is the input means, while viewing figures (such as icons or the like), texts, or the like which correspond to a variety of inputtable operations. It is therefore possible to provide a use interface which is user friendly irrespective of a user.

Further, in an electronic device having multi-functions, it is also possible to display different figures (such as icons or the like), texts, or the like in accordance with which application is used, the figures, texts, or the like corresponding to inputtable operations. This makes it possible to simplify input means that is otherwise very complex. Further, it is also possible to flexibly change an arrangement of display, though mechanical input means has a limitation that a predetermined arrangement cannot be changed.

Moreover, the electronic device includes the display device described above. This makes it possible to provide a user interface which is user-friendly irrespective of a use environment and a user. It is therefore possible to realize an electronic device which has a very advantageous in operator's operability over an electronic device including a conventional touch panel which includes only one of the planar operation section and the non-planar operation section.

Sizes, materials, shapes, relative positions, and the like of constituents described in embodiments are merely illustrative. Unless otherwise noted, the scope of the present invention is not limited to any of them.

### INDUSTRIAL APPLICABILITY

The present invention is applicable to (i) a touch panel which is provided, to an electronic device, as input means for operating the electronic device, (ii) a display device including the touch panel, and (iii) an electronic device including the display device.

### REFERENCE SIGNS LIST

1. electronic device
2. display operation surface
2a. input operation surface
3. first operation section (first region)
4. second operation section (second region)
5. touch panel
5a. transparent conductive film
5b. transparent substrate
6. liquid crystal display device (display means)
8. flexible display device (display means)

1. A touch panel, which is provided to an electronic device, the touch panel comprising:
a display operation surface including an input operation surface that constitutes at least a part of the display operation surface, the input operation surface being configured to be directly touched by a user so that an input operation is performed,
the input operation surface having a first region and a second region which are provided in a single substrate, the first region of the input operation surface being planar and substantially flat, and the second region of the input operation surface being protruded and/or recessed with respect to a reference plane which is the first region of the input operation surface.

2. The touch panel as set forth in claim 1, wherein:
the display operation surface has a part other than the input operation surface, the part of the display operation surface having at least a substantially flat part for mounting thereon a terminal for connecting a driving circuit to an external member to or fixing the touch panel to a predetermined position.

3. The touch panel as set forth in claim 1, wherein:
in the first region of the input operation surface, whether the input operation is performed or not is determined based on whether the user touches an input surface or not; and
in the second region of the input operation surface, a state of the input operation is determined, based on a direction in which a touch point at which the user touches the input surface moves and a distance by which the touch point moves.

4. The touch panel as set forth in claim 1, wherein the second region has at least a part having a dome shape, an ellipse shape, or a conical shape.

5. The touch panel as set forth in claim 1, wherein the substrate has a uniform thickness.

6. The touch panel as set forth in claim 1, wherein the touch panel is a capacitive touch panel.

7. The touch panel as set forth in claim 6, further comprising an electrode section for determining whether the user touches the input surface or not, the electrode section being provided in that side of the substrate which is opposite to the input operation surface.

8. The touch panel as set forth in claim 7, wherein the electrode section is single-layered.

9. A display device, comprising a touch panel as set forth in claim 1, and display means provided behind the display operation surface.

10. The display device as set forth in claim 9, wherein the display means is flexible and has a shape corresponding to the first region and the second region.

11. An electronic device, comprising a display device as set forth in claim 9.
